(19) United States
(12) Patent Application Publication
(10) Pub. No.: US 2002/0067820 A1
(43) Pub. Date: Jun. 6, 2002

(54) CALL MANAGEMENT SYSTEM USING COMBINED CALLING LISTS

(76) Inventors: PAUL BENSON, WINCHESTER (GB); ALAN ADRIAN IMPEY, SALISBURY (GB)

Correspondence Address: IB CORP, IP LAW DEPT, T J WATSON RESEARCH CENTER, PO BOX 218, YORKTOWN HEIGHTS, NY, 10598

(21) Appl. No.: 09/175,526

(22) Filed: Oct. 20, 1998

(30) Foreign Application Priority Data
Mar. 31, 1998 (GB) 9806979.2

(51) Int. Cl. H04M 3/00; H04M 5/00

(52) U.S. Cl. 379/265.02; 379/266.07

(57) ABSTRACT

A method of managing a call system for a computer telephony integrated call center system, said call center system comprising two or more customer call lists for at least one business telephony application, said method comprising: retrieving customer records for the same customer from a number of call lists; and combining said customer records to form a combined call list for said customer. A plurality of combined call lists for a plurality of customers is stored in a combined call list database. When ever a call is outbound to a customer or inbound to a customer the combined list for that customer is displayed so that calls to that customer can be managed.

### FIELD OF INVENTION

This invention relates to a call management system for a telephony call centre. In particular it relates to a call management system for inbound and outbound calls.

### BACKGROUND OF INVENTION

A call centre can be defined as a place in a company or business that handles inbound (incoming) and/or outbound (outgoing) calls to/from its customers in support of its day-to-day operation. This can be a telemarketing area, where the employees make outgoing calls to try and sell the company's products. It can be a service area that receives incoming calls from its customers for repair or maintenance of the company's goods or services. A call centre will have a telephone system which may be as simple as a small single-line phone, increasing in complexity up to a large multi-node PBX. A call centre would normally have a computerized system for tracking, logging and recording call details, although some simply use paper forms.

A common interface between a company and its customers is by telephone. It is therefore important that the call centre project an image that gives a customer a positive impression of the company they are dealing with. This can be achieved when the telephony communication with customers uses a single call centre. In practise however the telephony activity in a company is more often than not spread across different call centres and multiple departments which makes it very difficult to co-ordinate the telephony interactions with any individual customer. This lack of co-ordination can give rise to the following situations that leave the customer with a negative impression of the company. A customer may be called multiple times on the same day by different departments about different matters. Customers, who are bad debts, may be called by the telesales department to be sold new services. Also customers calling the company are greeted by agents who are unaware of who else the customer has been talking to that day or of the difficulties that the customer may have had in contacting the call centre if it has been busy.

It is a problem in a call centre is for a customer service representative (CSR) to know call activity and planned activity for a particular customer on a particular day. For example a customer may appear in multiple call lists for different reasons and also may also make calls in for ordering or enquires.

### SUMMARY OF INVENTION

According to one aspect of the invention there is provided a method of managing a call system for a computer telephony integrated call centre system, said call centre system comprising two or more customer call lists for at least one business telephony application, said method comprising: retrieving customer records for the same customer from a number of call lists; and combining said customer records to form a combined call list for said customer.

This solution has the call management system provide a CSR with daily call history and planned contact for the day for a particular customer. This enables the CSR to use company strategy for dealing with multiple customer activities in a day. This helps the company to avoid multiple calls to a customer in one day. It can increase the efficiency of the CSRs; improve the call centre image; improve customer service; and provide dynamic reporting of activity.

Advantageously the method further comprising forming a plurality of combined call lists for a plurality of customers and storing said plurality of combined call lists in a combined call list database. More advantageously the method further comprising creating a new record to indicate the progress of an outbound call when an outbound call is initiated.

Preferably the call management system provides a call centre agent with details of all the actual and planned telephony contact with a customer before the agent either receives an inbound call or initiates an outbound call. This information allows the agent to deal with inbound calls from customers more sympathetically by knowing who the customer has already been in contact with that day and the number of attempts that customer may have had to make to contact the call centre.

For outbound calls it may provide the agent with information about the other telephone contacts with this customer, which enables the agent to make the decision of whether to initiate the call or not. In addition if they do decide to make the call, they can provide a higher level of customer service by giving the customer the impression that they are aware of all the other calls that the customer has been involved in.

The input to the application is preferably a customer account number, this is used to identify and retrieve the actual and planned telephony activity with this customer. For inbound calls the account number is advantageously derived automatically from the CLI/ANI information that is associated with the inbound call. When this information is not available from the telephone network then it can found by the agent performing a search on the customer database using some piece of information that the customer has provided verbally, e.g. the post code or surname of the caller.

For outbound calls the account number is retrieved from: the outbound call list that the agent is using; the account information if this is displayed on the agent workstation; or database search using the customer's telephone number if the call is initiated through an application.

Preferably when the outbound call is made using a business application then the window will appear before the call is initiated providing the agent with the opportunity to cancel the call. More preferably if the call is dialled manually then the window will still appear but there will be no opportunity to cancel the call.

The application provides an advisory window on the agents computer screen that contains the following information about the identified customer. The calls that have either been received from or made to that customer for that day together with names of the individuals and departments spoken to. Planned future calls to be made to that customer. The number of abandoned calls that the customer has experienced. Additional information about the customer that the company may consider to be particularly useful in helping the agent deal with the customer. For example, their business status or perhaps a warning if they had made frequent complaints.

It is advantageous that all outbound call lists updated to show that the customer has been contacted.

For each inbound call the program will: create an entry in the Inbound call log; check all the outbound call lists for planned calls to this customer; check the abandoned call list; check the customer data base for any special information; and display the information in a window on the agent's workstation.

For each outbound call the program will: check the Inbound call log for any calls that the call centre may have received form this customer; check the abandoned call list; check the customer data base for any special information; check all the outbound call lists for any completed or additional calls that may be made to this customer; and display the information in a window on the agent's workstation.

### BRIEF DESCRIPTION OF DRAWINGS

In order to promote a fuller understanding of this and other aspects of the present invention, an embodiment will now be described, by way of example only, with reference to the accompanying drawings in which:

FIG. 1 is a schematic representation of a call centre of the embodiment;

FIG. 2 is a more detailed representation of the platform on which the embodiment resides;

FIG. 3 is a schematic process of a Combine Call List component;

FIG. 4 is a schematic process of an Outbound component;

FIG. 5 is a schematic process of an Inbound component;

FIG. 6 is a schematic process of an advisory window component; and

FIG. 7 is a schematic of an GUI advisory window.

### DETAILED DESCRIPTION OF PREFERRED EMBODIMENT

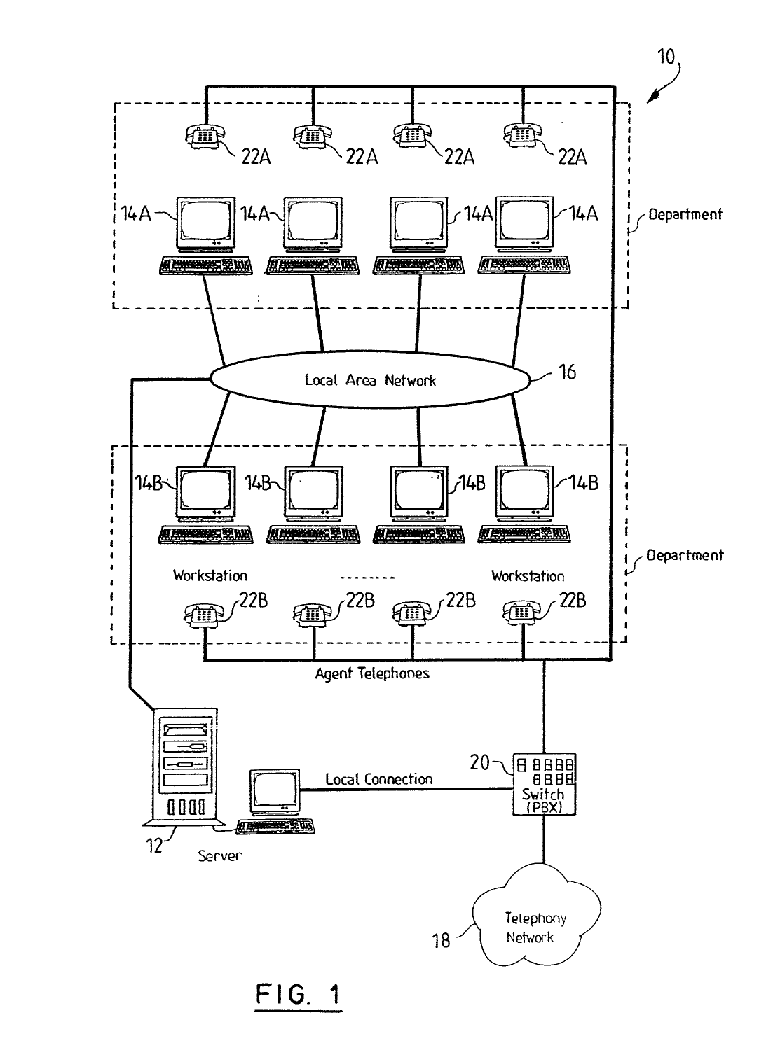

Referring to FIG. 1 there is shown a typical call centre 10 or Automatic Call Distribution (ACD) arrangement. A PC based computer server 12 is connected to a number of PC based computer clients 14A, 14B or agent workstations by a local area network (LAN) 16. The server 12 has a data link to a telephony network 18 through a switch 20. Connected to the telephony network through the switch 20 are agent telephones 22A, 22B corresponding to each of the agent workstations 14A, 14B. The workstations and telephones are arranged into two departments: department 1 corresponding to workstations 14A and telephones 22A; and department 2 corresponding to workstations 14B and telephones 22B.

The switch 20 makes, breaks or changes the connections between telephone lines in order to establish, terminate, or change a telephone call path. It is typically a private branch switch residing on the same premises as the server 12. The switch 20 would typically be a Siemens Hicom* 300 but could be one of many suitable switches provided amongst others by Lucent, Nortel or Alcatel. The switch provides network information to the telephony application such as ANNI (answer number identification, also known as Caller Line Identification (CLI)) and DNI (dialled number identification).

The server 12 is typically a Pentium based PC with 192M bytes of memory, 25G bytes of hard drive, keyboard, mouse, and VDU connected to the LAN using an ethernet card. A suitable operating system 24 is OS/2 Warp but Microsoft's Windows NT* would also be suitable. On top of the operating system is an application/database layer 26.

A telephony application 28 controls the switch 12 for the call centre and performs intelligent dialling functions and transfer calls function. A call management system 30 provides the functionality of the embodiment.

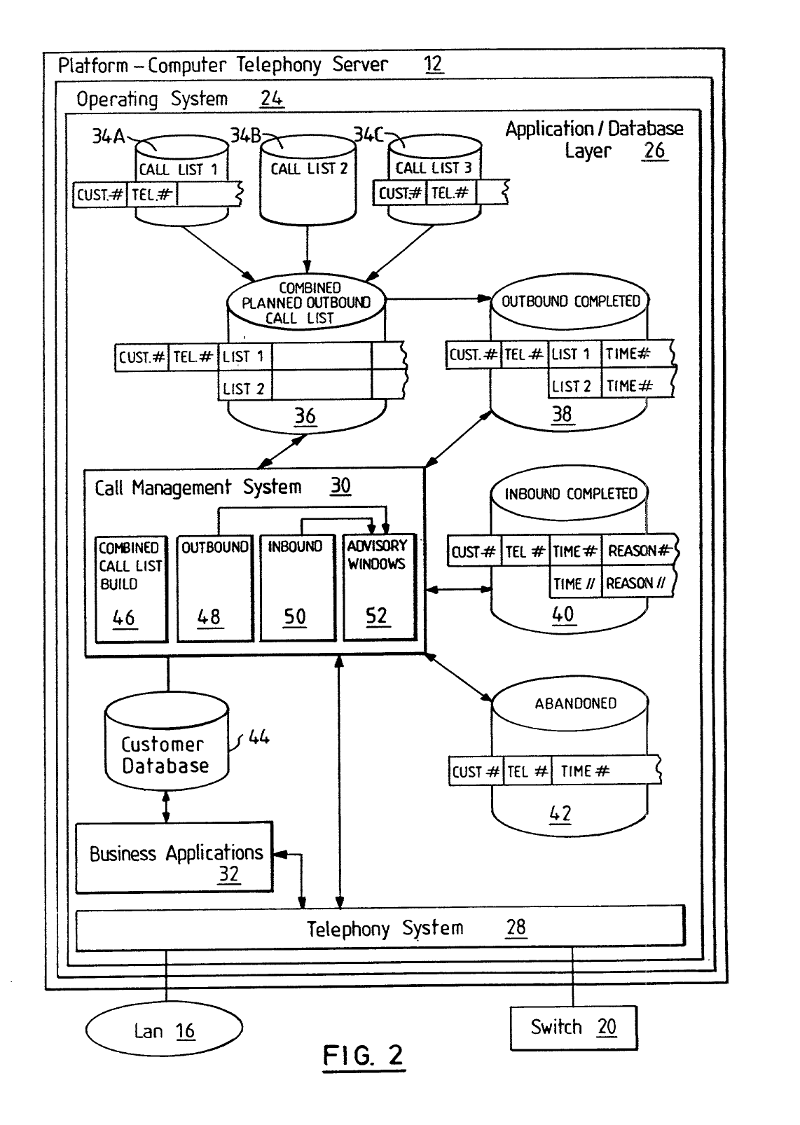

The layer 26 provides an area of memory reserved for storing databases used by the telephony application 28, call management system 39 and business applications 32 (see FIG. 2).

Each workstation 14 is typically a pentium microprocessor based PC with 32M bytes of memory, 4Gbytes of hard drive, keyboard, mouse and VDU connected to the LAN using an Ethernet card. A suitable operating system is IBM's OS/2 Warp running the workstation application which communicates with the server. The workstation application sends and receives messages from the switch 20 through the LAN 16 and the telephony application using an application programming interface which is part of the telephony application 28.

The application/database layer 26 contains the call list databases 34A,B,C used by one or more business application 32. For instance call list 34A may be a sales call list for department 1 (the sales department) and call list 34B may be a debitors list for department 2 (the debit collection department). The application/data base layer 26 contains databases used by the call management system 30, namely: a combined outbound call list 36; an outbound completed database 38; an inbound completed database 40 and an abandoned call database 42. The application/database 26 also contains a customer database 44 used by one or more of the business applications 32 and the call management system 30.

One example of a business application is telesales application which prompts an agent with certain selling strategies for use with a customer. Another example is a sales order application which will accept input from an agent so that sales details can be taken. Another example is an customer enquiry application which accepts input from an agent regarding a customer problem for instance a brief description of the problem, the time which it is entered, the priority which it should be handled. Some of the business application data is stored in the customer database and the rest is stored in an application specific database.

The customer database 44 is associated with the telephony application and business applications and stores information about customers. It may be accessed by the agent during a conversation with the customer to add notes, place orders or what ever the business application needs. The structure and the fields in the customer database are application specific. In the example of the embodiment a sales ordering application is running on the server and accesses the customer database to place an order. A GUI screen pop is displayed on a workstation VDU by the sales ordering application so that the agent can enter the order details taken form the customer over the telephone. The sales ordering application has a primary record for each customer including a customer name field; a ANNI identification field; and an address field. For each customer record there are many order records, linked to the customer record by the name and having an order number field, a field for the call number of that the order was taken on, a field for the agent who took the call, and a field for the total value of the order. This is only an example of a customer database and many alternative structures, fields and applications may be used.

The call management system comprises: a combined call list build component 46; an out bound component 48; an inbound component 50; and an advisory window component 52.

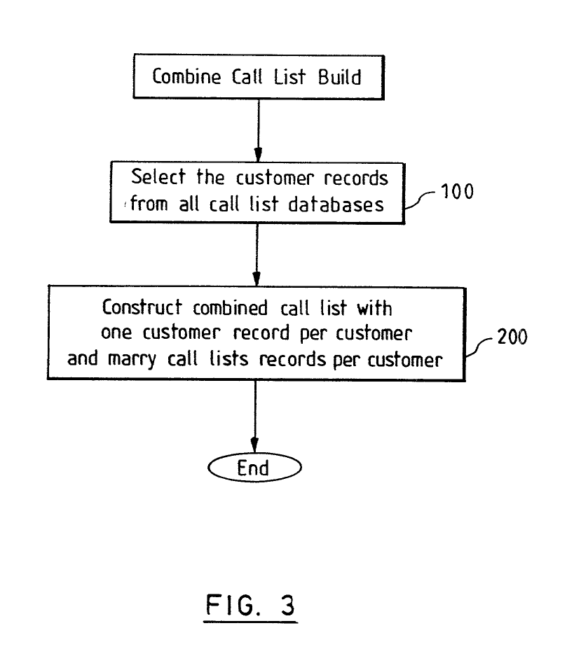

The combine call list build component constructs the combined call list from all the call lists. It selects the customer records from all the call list databases 34A,B,C in step 100 (see FIG. 3). Then it constructs a single combined call list with one customer record per customer and many call lists records per customer in step 102. Where all the call lists are stored in the application/database layer 26 this operation is a relatively simple database language command for instance in the popular SQL language the statements select all and union cust# would be used to build the combined call list. However, the process is not very much different when the call lists are on different servers, for instance on an enterprise call centre where there may be several local area networks in geographically separated areas. The LAN servers can communicate messages to each other and shadow call lists can be assembled on the call management server so that the same combining process can be used. In this embodiment the combined list is constructed in one go, normally the night before the call lists are to be used. This is probably the quickest way of achieving single customer records associated with many call list records when there are large numbers of calls to be made. However is possible to construct a single customer record with its multiple call lists dynamically from the call lists if the system was fast enough.

The call management system 30 operates independently of the business application. It communicates with the telephony system 28 and receives the same telephony events that the business application will receive. For instance, when a telesales business application initiates a call and the call is answered, a telephony answer event is received by the telesales application so that the prompts are displayed to the agent. At the same time, the same telephony event is received by the call management system so that the outbound component can be initiated.

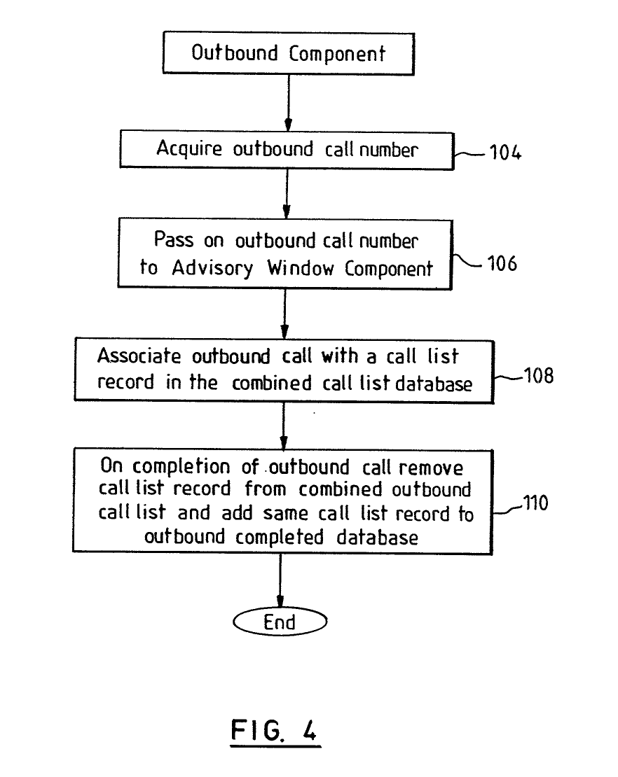

The outbound component receives a call initiated telephony event which contains the telephone number of the customer called. In this way the outbound call number is acquired—step 104 (see FIG. 4). Once the outbound call number is acquired it is passed on to the advisory window component 52, step 106, which processes the call number independently. Next the outbound call is associated with a call list record in the combined call list database—step 108. Then on completion of the outbound call, indicated by a telephony event from the telephony system, the call list record is removed from the combined outbound call list and added to the outbound completed database 38—step 110. The time that the telephony event occurred is also added to the outbound completed database 38.

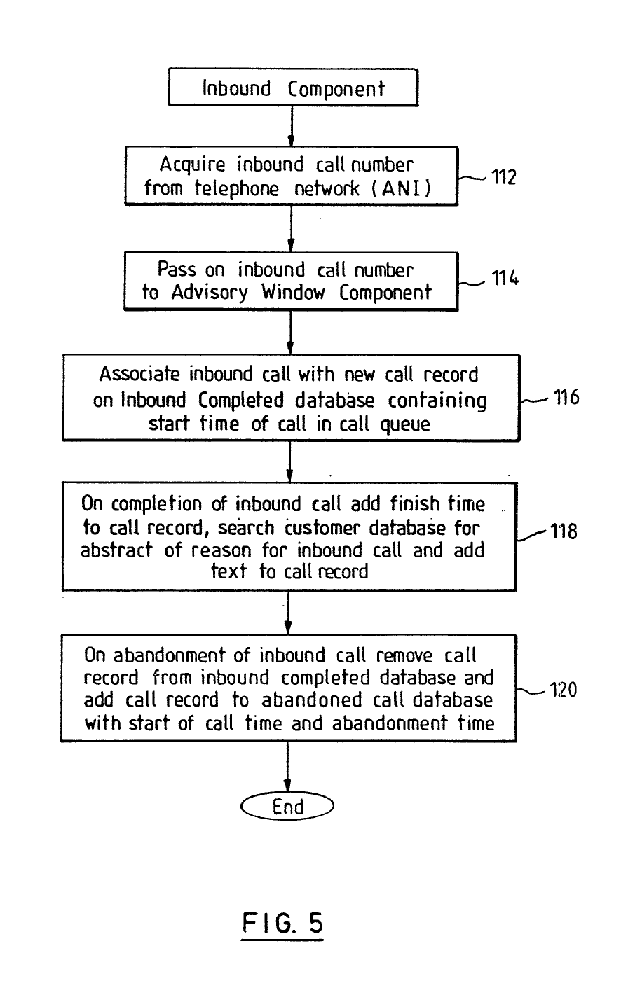

The inbound component operates in a similar way. First inbound call number is acquired from the telephone network using an automatic number identification (ANI) system or similar—step 112 (see FIG. 5). Then this number is passed on to the advisory window component so that the customer details can be displayed—step 114. Next a new call record is added to the inbound completed database 40 and associated with the call, the start time of the call is placed in the call record as is wait time before an agent answers, step 116. Note that this database is independent from any of the business application that handle inbound calls. For instance an enquiry application will set a new record to its own database to handle the enquiry in parallel with the inbound completed database 40. If the inbound call is completed the appropriate telephony event will be received by the call management system and the end time of the inbound call is entered into the call record in the database—step 118. Details of the enquiry would be usefully entered or referenced in the inbound completed database 40 as part of the call record. This may be entered directly by the agent or cut and past from a similar entry in a business application that also handles inbound calls. In this embodiment a similar abstract field exists in the business application and it is copied directly into the inbound completed database. Alternatively a reference to the entry in the business application could be directly entered by the inbound component. If the inbound call is abandoned by the customer before it is answered by the agent then the call record is removed form the inbound completed database and added to the abandoned call database, the start time and wait time is also entered into the abandoned call database—step 120.

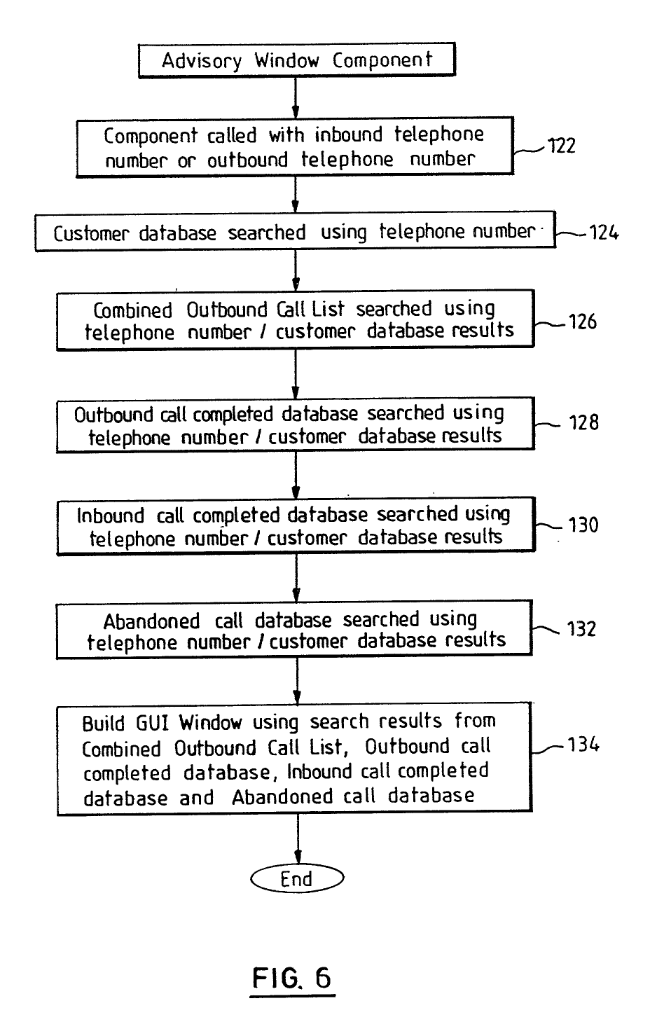

The advisory window component is accessed by the outbound component or the inbound component with an outbound telephone number or inbound telephone number respectively—step 122 (see FIG. 6). In this embodiment there is no different treatment of the two different types of call because all the information is displayed in the window. However it may be that for outgoing calls the outbound completed calls and the planned outgoing calls would be displayed more prominently or for incoming calls it would be important to display the abandoned calls and other completed incoming calls. The databases may be searched with the telephone number alone but it is advantageous to use two search key in case there is corrupted data for one of the search keys. The customer data base is searched using the telephone number as a key and the customer name or account is located—step 124. Next the combined outbound call list is searched using both keys and the customer record located—step 126. Then the outbound call completed database is searched using both keys and the customer record located—step 128. The Inbound completed database 40 is next searched with both keys and the customer record located—step 130. The last search is abandoned call database and the customer record located—step 134. Finally the GUI window is display using the located customer records from the databases—step 134.

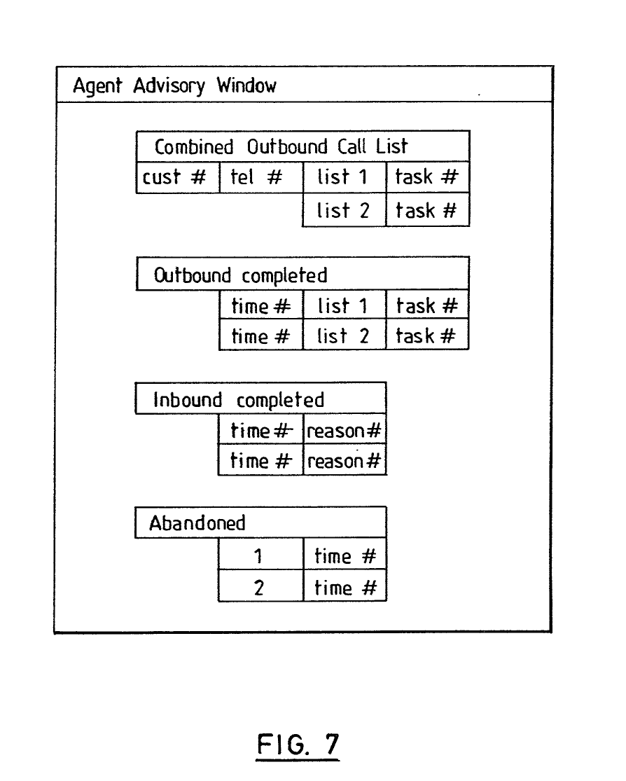

The GUI advisory window is shown in FIG. 7. The customer records are shown in a simple column format. At a glance the agent can see all the information about other calls made or to be made to the customer. The advisory window component further comprises GUI link functionality allowing the agent to initiate business applications from the advisory window. The agent is able to select a task from the combined outbound call list and the appropriate business application is called with the appropriate task.

In summary the is described a method of managing a call system for a computer telephony integrated call centre system, said call centre system comprising two or more customer call lists for at least one business telephony application, said method comprising retrieving customer records for the same customer from a number of call lists; and combining said customer records to form a combined call list for said customer. A plurality of combined call lists for a plurality of customers is stored in a combined call list database. When ever a call is outbound to a customer or inbound to a customer the combined list for that customer is displayed so that calls to that customer can be managed.

1. A method of managing a call system for a computer telephony integrated call centre system, said call centre system comprising two or more customer call lists for at least one business telephony application, said method comprising:
retrieving customer records for the same customer from a number of call lists; and
combining said customer records to form a combined call list for said customer.

2. A method as claimed in claim 1 further comprising forming a plurality of combined call lists for a plurality of customers and storing said plurality of combined call lists in a combined call list database.

3. A method as claimed in claim 2 further comprising creating a new record to indicate the progress of an outbound call when an outbound call is initiated.

4. A method as claimed in claim 3 wherein said outbound call progress record is created in a separate outbound call database.

5. A method as claimed in claim 4 wherein said outbound call progress record contains data relating to the customer that the call was made to.

6. A method as claimed in claim 5 further comprising recording in the out call progress record when the call is completed and/or which call list the call was initiated form.

7. A method as claimed in claim 6 further comprising creating a new record to indicate the progress of an inbound call for the call centre.

8. A method as claimed in claim 7 wherein said inbound call progress record is created in a separate inbound call database.

9. A method as claimed in claim 8 wherein said inbound call progress record contains data relating to the customer who initiated the call.

10. A method as claimed in claim 9 further comprising recording in the inbound call progress record when the call is completed and/or the reason for the call.

11. A method as claimed in claim 10 further comprising displaying said combined call list for a customer on initiation of an outbound call to that customer or an inbound call from that customer.

12. A method as claimed in claim 11 further comprising displaying the outbound call progress records for a customer on initiation of an outbound to that customer or inbound call from that customer.

13. A method as claimed in claim 12 and as dependent on claim 7 further comprising displaying the inbound call progress record for a customer in initiation of an outbound call to that customer or an inbound call from that customer.

14. A call management system for a computer telephony integrated call centre system, said call centre system comprising two or more customer call lists for at least one business telephony application, said call management system comprising:
means for retrieving customer records for the same customer from a number of call lists; and
means for combining said customer records to form a combined call list for said customer.

15. A system as claimed in claim 14 further comprising means for forming a plurality of combined call lists for a plurality of customers and storing said plurality of combined call lists in a combined call list database.

16. A system as claimed in claim 15 further comprising means for creating a new record to indicate the progress of an outbound call when an outbound call is initiated.
